(19) United States
(12) Patent Application Publication
(10) Pub. No.: US 2022/0229484 A1
(43) Pub. Date: Jul. 21, 2022

(54) POWER MANAGEMENT SETTING CONFIGURATION

(71) Applicant: Hewlett-Packard Development Company, L.P., Spring, TX (US)

(72) Inventors: Devi Vellingiri, Bangalore (IN); Anusha ., Bangalore (IN); Puviyarasu Velumani ., Bangalore (IN)

(73) Assignee: Hewlett-Packard Development Company, L.P., Spring, TX (US)

(21) Appl. No.: 17/609,428

(22) PCT Filed: Jun. 22, 2020
(86) PCT No.: PCT/US2020/038914

§ 371 Date: Nov. 8, 2021

(30) Foreign Application Priority Data
Sep. 17, 2019 (IN) IN201941037410

(51) Int. Cl. G06F 1/3228; G06F 1/3246

(52) U.S. Cl. CPC G06F 1/3228; G06F 1/3246

(57) ABSTRACT

An example non-transitory computer-readable storage medium comprises instructions that, when executed by a processing resource of a computing device, cause the processing resource to receive usage data of a device. The usage data comprises a plurality of time-intervals and a number of times that least a single job is performed by the device in each of the time intervals. The instructions further cause the processing resource to determine, using the usage data, a probability of a job being requested during a particular time-interval, and to configure power management settings of the device for the particular time-interval depending on the probability.

### BACKGROUND

Devices such as desktops, laptops, tablets, phones, monitors, televisions, printers, network switches, storage area networks, firewalls have power management capabilities. These devices may allow a user to configure the power management. For example, setting up the power management may include turning off a display after inactivity for a certain predefined time-interval, or putting the device to sleep after inactivity for a certain predefined time-interval, or turning off a component of a device—like a network port, a sensor, etc. after inactivity for a certain predefined time-interval.

### BRIEF DESCRIPTION OF THE DRAWINGS

The following detailed description references the drawings, in which:

FIG. 1 depicts a device and a computing device, the latter determines power management settings of the device according to examples described herein;

FIG. 2 depicts a flow diagram of a method 200 for automatically configuring power management settings of a device according to examples described herein;

FIG. 3 depicts example usage data of a device used for determining power management settings of the device according to examples described herein;

FIG. 4 example usage data of a device used for determining power management settings of the device according to examples described herein;

FIG. 5 depicts a comparison of energy consumed using power management settings that are manually configured and that are automatically configured according to examples described herein; and

FIG. 6 depicts a flow diagram of a method 600 for automatically configuring power management settings of a device according to examples described herein.

### DETAILED DESCRIPTION

Power management is a desirable feature to users of electronic devices, such as printers, monitors, computers, and the like, for conserving energy. For example, a user of a printer or any other electronic device may configure an energy-saving feature as per his/her needs. These configurations are based on user assumptions and not on real-time device usage data. As a result, the device may be put in a “sleep” state more frequently than a frequency at which jobs are received by the device, where the device consumes minimal energy in the sleep-state. If a job has to be executed during the sleep-state, retrieving the device from the sleep-state into an “operational” state may take time, causing the user to wait. The device consumes additional energy during such a transition. Alternatively, the device may be put in the sleep-state more infrequently than the frequency at which jobs are received. In this case, the amount of energy consumed can be saved. Hence, manually configuring the power management settings based on user assumptions is not an optimal method for achieving maximum energy-saving. A technical challenge exists for a seamless approach to enable optimal power management based on usage data of the device, rather than user assumptions.

Various implementations of technical solutions to such technical challenges are described herein by referring to several examples of automatic configuration of power management settings of devices. Here, a device is monitored over a period of time and the usage data is collected for the device. The usage data is analyzed with machine-learning algorithms. Based on the analysis the power management configuration of the device is updated for optimal energy conservation as well as having the device available when a job is to be executed.

In one example implementation, a non-transitory computer-readable storage medium is provided. The computer-readable storage medium stores instructions that, when executed by a processing resource, cause the processing resource to receive the usage data of the device and determine the power management settings for the device. The processing resource transmits the power management settings to the device, which in turn updates the settings. In an example implementation, the processing resource is part of the device itself. In an example implementation, the processing resource is part of a computing device, separate from the device for which the power management settings are determined. Other example implementations of automatically updating power management settings are described below.

The technical solutions described herein facilitate automatically configuring power management settings for the device, such as a printer. The power management settings are determined based on an analysis of usage data of the device, for example, using a machine learning algorithm. The usage data of the device may be parsed and/or filtered to identify energy state events corresponding to sleep and wake-state changes caused by job requests. The usage data is analyzed to determine the probability of occurrence of a job during particular time-intervals. Based on the analysis, power management configurations/settings for the device are determined. For example, a sleep timeout value may be determined. The device is put in the sleep-state after being in an idle state for the sleep timeout value. Alternatively, or in addition, sleep duration may also be computed, which is indicative of how long the device is to be in the sleep-state.

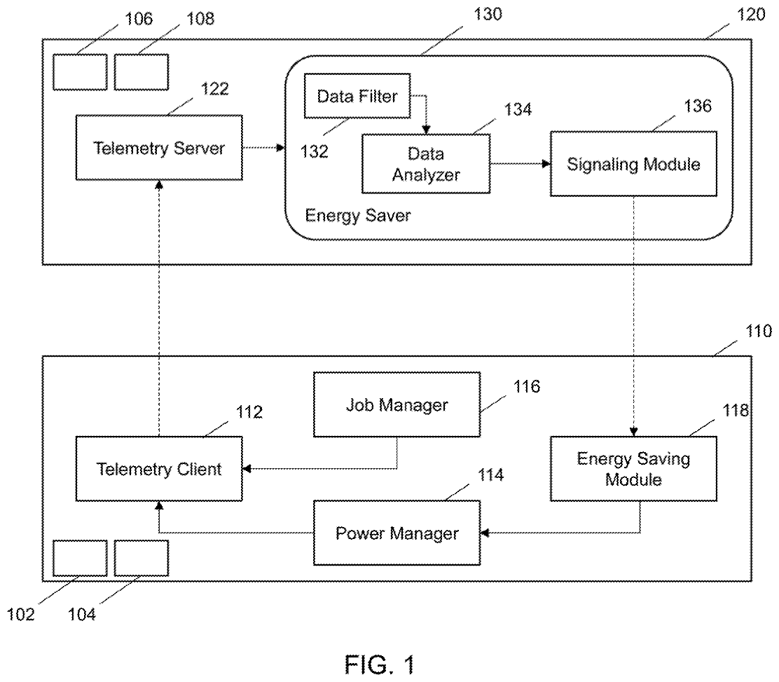

FIG. 1 includes components, modules, engines, etc. according to various examples as described herein. In different examples, more, fewer, and/or other components, modules, engines, arrangements of components/modules/engines, etc. can be used according to the teachings described herein. In addition, the components, modules, engines, etc. described herein can be implemented as software modules executing machine-readable instructions, hardware modules, special-purpose hardware (e.g., application-specific hardware, application-specific integrated circuits (ASICs), field programmable gate arrays (FPGAs), embedded controllers, hardwired circuitry, etc.), or some combination of these.

FIG. 1 relates to components and modules of a device 110 for which the power management is to be configured, such as a printer. A computing device 120 is also depicted in FIG. 1, where the computing device 120 analyzes the usage data of the device 110. Although the computing device 120 is depicted as a separate block, in one example, the computing device 120 can be part of the device 110 itself. In another example, the computing device 120 and the device 110 are separate devices that communicate with each other via a wired or wireless communication network, such as a local area network (LAN), Internet, or any other communication network. For example, the computing device 120 can be a computer server that is remote to the device 110. Further, in an example, the computing device 120 can be in communication with multiple devices 110 to configure the power management for each of those devices 110.

In examples, the device 110 and the computing device 120 are any appropriate type of devices, such as smartphones, tablets, desktops, laptops, workstations, servers, printers, smart monitors, smart televisions, digital signage, scientific instruments, retail point of sale devices, video walls, imaging devices, peripherals, networking equipment, wearable computing devices, or the like.

FIG. 1 depicts the device 110 having a telemetry client 112, a power manager 114, a job manager, and an energy-saving module 118. The computing device 120 includes a telemetry server 122 and an energy saver 130. The energy saver 130 in an example includes a data filter 132, a data analyzer 134, and a signaling module 136.

The telemetry client 112 and the telemetry server 122 communicate with each other so that the telemetry client 112 can transmit a stream of event data to the telemetry server 122. Telemetry is an automated communications process by which data associated with the device 110 are collected and provided as part of the stream of event data. In an example, the event data that is collected and streamed includes data from the job manager 116 and the power manager 114. In an example, the data is collected in response to a trigger. Alternatively, or in addition, the data is collected on a periodic basis.

For example, the telemetry client 112 can include in the stream of event data a power state and a wake trigger information of the device 110. Each “event” in the stream of data has at least two fields—a power state and a wake trigger.

The power state has different possible states in which the device 110 can be configured. For example, the power state can be one of a sleep-state and wake-state. The sleep-state may be when the device 110 uses minimal energy (electric power) with several components of the device 110 inactive or switched off. The device 110 may be in a standby mode in the sleep-state and has to be put in the wake-state to handle a job request. The wake-state may be when the device 110 uses more energy compared to the sleep-state to perform the requested job.

The wake trigger has different values such as job, control panel, USB, network connect/disconnect, and the like. The wake trigger is indicative of a reason that the device 110 changed from one state to another, for example, the sleep-state to the wake-state, or from the wake-state to the sleep-state. As the device 110 enters into one of the predetermined states, like the sleep-state or wake-state, the telemetry client 112 pushes the power state event with the field information to the telemetry server 122. In some examples, the telemetry client 112 provides telemetry data at regular intervals, or the telemetry server 122 may pull telemetry data from the telemetry client 112.

The telemetry client 112 receives the information for the event from the job manager 116 and the power manager 114. For example, the job manager 116 indicates what caused the wake trigger, while the power manager 114 provides the present power state of the device 110.

The energy-saving module 118 changes the power management settings of the power manager 114. The energy-saving module 118, in an example, changes the power management settings based on an input received from the user. Alternatively, or in addition, the energy-saving module 118 changes the power management settings based on an input received from the energy saver 130. In an example, the energy-saving module 118 compares the received input from the energy saver 130 with the present power management settings of the power manager 114. If the present power management settings are different from those that are input, the energy-saving module 118 updates the settings of the power manager 114. In an example, the energy-saving module 118 is a daemon process that is continuously executing on the device 110.

The energy saver 130 provides the power management settings to the energy-saving module 118 based on an analysis of the stream of event data from the telemetry client 112. The energy saver 130 can analyze the event data using a machine learning algorithm.

Analyzing the event data includes filtering the event data to identify particular information. For example, after a predetermined period, for example, every 48 hours, the data filter 132 block fetches the telemetry data received by the telemetry server 122 during the most recent period. The telemetry server 122 can receive other types of data from the telemetry client 112 for other applications, and hence the telemetry data received can include data that may not be relevant to the energy saver 130.

The data filter 132 filters the telemetry data to identify the power state events and job events. In an example, the data filter 132 identifies events in which the device 110 transitioned into the sleep-state or wake-state such that the transition was triggered due to a job. The data filter 132 accordingly filters the telemetry data as well as the event data so that the non-job wake events like control panel interaction, network connectivity are not considered during the analysis. Such events are deemed occasional and not consistent real-time data for the energy-saving analysis.

The data analyzer 134 processes the filtered event data to determine optimal power management settings for the device 110. In an example, the data analyzer 134 uses the “Naive Bayes” algorithm to understand the power state transitions that occurred over a time period based on the filtered data. Based on the occurred events, the data analyzer 134 determines a power management setting and a wake event frequency due to jobs requested of the device 110. The power management settings determined by the energy saver 130 can include a sleep timeout value, an auto-off timing, a schedule for turning the device 110 ON and OFF, etc.

In an example, the data analyzer 134 determines a value for the power management setting of the device 110 using the following formula and the filtered data: P(c|x)=P(X|C)P(c)/P(x), where c represents the occurrence of a job, x represents a time-interval, and P(i) represents a probability of ‘i’ occurring. Here P(c|x) is a posterior probability of job occurrence in the given time interval. The posterior probability is calculated based on the probability of overall job occurrence P(c) and the probability of job occurrence in the given time interval P(x|c). P(x) is the probability of the time interval.

Once the sleep timeout value is computed based on the calculated probabilities in this manner, the signaling module 136 sends the sleep timeout value to the energy-saving module 118 of the device 110. Sending the sleep timeout value can include determining if the resulted sleep timeout value is different from the present timeout value being used by the device 110, in an example. Further, in an example, sending the sleep timeout value can include packing the sleep timeout value in a communication message according to a communication protocol being used, along with the appropriate header(s). The energy-saving module 118 sets the received sleep timeout as part of the settings of the power manager 114.

Further, referring to FIG. 1, device 110 includes a processing resource 102 that represents any suitable type or form of processing unit or units capable of processing data or interpreting and executing instructions. For example, the processing resource 102 includes central processing units (CPUs), microprocessors, and/or other hardware devices suitable for retrieval and execution of instructions. The instructions are stored, for example, on a non-transitory tangible computer-readable storage medium, such as memory resource 104, which may include any electronic, magnetic, optical, or other physical storage devices that store executable instructions. Thus, the memory resource 104 may be, for example, random access memory (RAM), electrically-erasable programmable read-only memory (EEPROM), a storage drive, an optical disk, and any other suitable type of volatile or non-volatile memory that stores instructions to cause a programmable processor to perform the techniques described herein. In examples, memory resource 104 includes a main memory, such as a RAM in which the instructions are stored during runtime, and a secondary memory, such as a nonvolatile memory in which a copy of the instructions is stored.

Alternatively or additionally in other examples, the device 110 includes dedicated hardware, such as integrated circuits, ASICs, Application-specific Special Processors (ASSPs), FPGAs, or any combination of the foregoing examples of dedicated hardware, for performing the techniques described herein. In some implementations, multiple processing resources (or processing resources utilizing multiple processing cores) may be used, as appropriate, along with multiple memory resources and/or types of memory resources.

The computing device 120 includes a processing resource 106 that represents any suitable type or form of processing unit or units capable of processing data or interpreting and executing instructions. For example, the processing resource 106 includes central processing units (CPUs), microprocessors, and/or other hardware devices suitable for retrieval and execution of instructions. The instructions are stored, for example, on a non-transitory tangible computer-readable storage medium, such as memory resource 108, which may include any electronic, magnetic, optical, or other physical storage devices that store executable instructions. Thus, the memory resource 108 may be, for example, random access memory (RAM), electrically-erasable programmable read-only memory (EEPROM), a storage drive, an optical disk, and any other suitable type of volatile or non-volatile memory that stores instructions to cause a programmable processor to perform the techniques described herein. In examples, memory resource 108 includes a main memory, such as a RAM in which the instructions are stored during runtime, and a secondary memory, such as a nonvolatile memory in which a copy of the instructions is stored.

Alternatively or additionally in other examples, the computing device 120 includes dedicated hardware, such as integrated circuits, ASICs, Application-specific Special Processors (ASSPs), FPGAs, or any combination of the foregoing examples of dedicated hardware, for performing the techniques described herein. In some implementations, multiple processing resources (or processing resources utilizing multiple processing cores) may be used, as appropriate, along with multiple memory resources and/or types of memory resources.

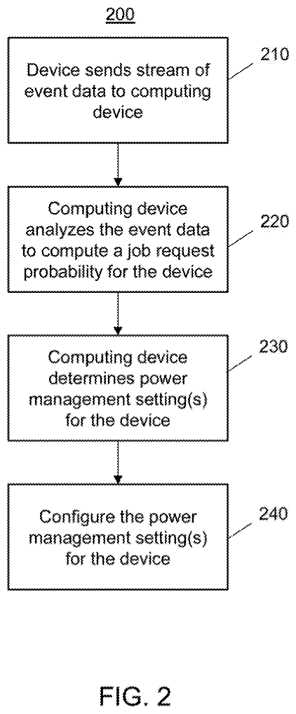

FIG. 2 depicts a flow diagram of a method 200 for automatically configuring power management settings of a device according to an example. The method 200 includes the device 110 sending the stream of event data to the computing device 120, at block 210. The sending includes compiling the event data using information from the job manager 116 and the power manager 114. The telemetry client 112 and the telemetry server 122 can perform the sending/receiving of the stream of the event data. In an example, the telemetry server 122 requests the telemetry client 112 to send telemetry data for a particular duration, for example, 48 hours, 72 hours, etc. The telemetry server 122 can request the data at a predetermined frequency equal to the particular duration. Alternatively, or in addition, the telemetry client 112 sends the stream of event data at the predetermined frequency. In other examples, the telemetry client 112 sends and/or the telemetry server 122 receives the event data on demand, for example, when the event data is generated.

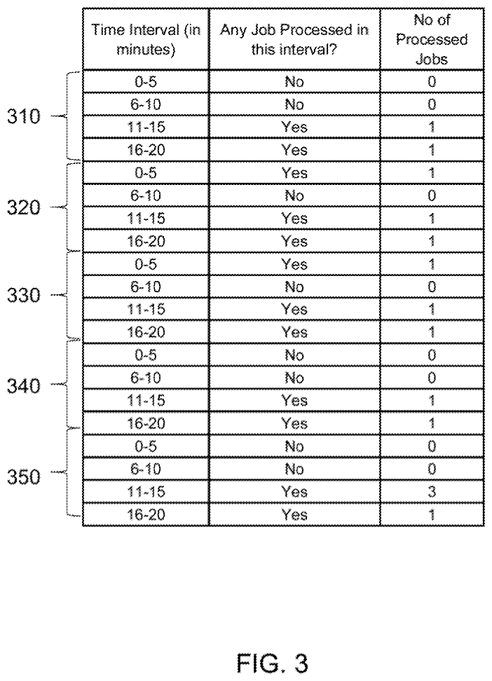

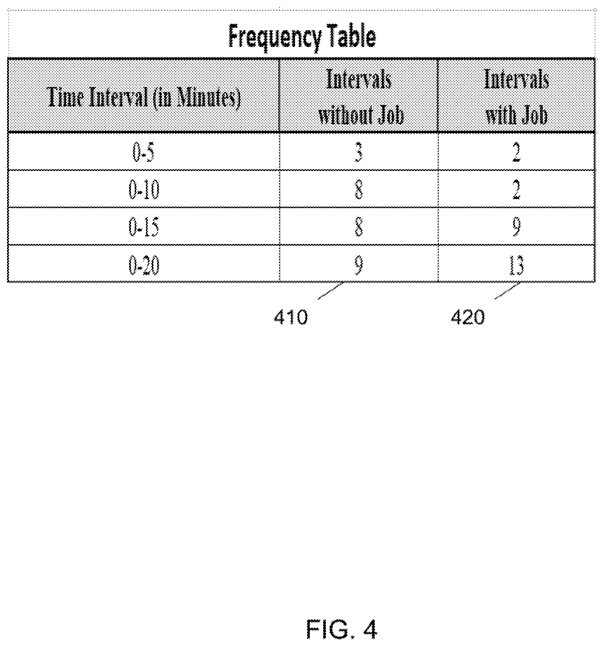

FIGS. 3-4 depict example data that is further used herein to describe the calculation for different time-intervals to identify an optimal sleep timeout value for the power management setting according to an example scenario. Although the calculation of the sleep timeout value for the device 110 is described herein, similar calculations can be performed for determining other types of power management settings such as the ON/OFF schedule, auto-OFF time, etc. for improving energy conservation of the device 110.

In the example data of FIG. 3, the present sleep timeout for the device 110 is configured to be 15 minutes, i.e., the device 110 transitions into sleep-state (e.g., from wake-state) after 15 minutes of idle time. It is understood that the sleep timeout can be configured to different value in other examples. In an example, the data analyzer 134 identifies the sleep timeout value based on the input data. Here, “idle time” represents a duration during which the device 110 does not receive a job request. The example data in FIG. 3 contains the job occurrences data for every 20-minute after wake event. Within each 20-minute cycle, the device 110 gets monitored for any job occurrences for intervals of 5 minutes. In other words, the sleep-wake cycle of the device 110, which is of a first duration (20 minutes) is split into multiple smaller periods of a second duration (e.g. 5 minutes). It is understood that the first duration and the second duration values can be different in other example implementations from the values used in the example scenario herein.

In FIG. 3, the first set 310 of 20 minutes duration has the details from a wake-state to the first transition to sleep-state of the device 110. Further, the second set 320 of 20 minutes duration has the details of a second transition from a wake-state to a sleep-state. Similarly, the third set 330, fourth set 340, and fifth set 350 depict further transitions of the device 110 from the wake-state to the sleep-state.

FIG. 4 depicts an accumulation of the event data that is performed by the data analyzer 134 in an example. Here, for each of the sleep cycles 310-350, each representing the first predetermined duration of 20 minutes, the data analyzer 134 captures a frequency of job occurrences in an interval of the second predetermined duration (5 minutes) across all of the sleep-wake cycles 310-350. The sleep week cycles 310-350 are represented by the sets of events in FIG. 3. In the example data from FIG. 4, the number of 5-minute intervals between the minute marks 0-5 that have no jobs processed is 3, while the number of 5-minute intervals between the 0-10 minute marks that have no jobs processed is 8. It should be noted that the 5-minute intervals between 0-10 minute marks are cumulative of the 5-minute intervals that were counted for the 0-5 minute marks. FIGS. 3 and 4 identify intervals with a job (420) and intervals without a job (410).

Referring to the flow diagram of FIG. 2, method 200 includes the computing device 120 analyzing the received event data to compute a job request probability for the device 110, at block 220. The calculations for the example data depicted in FIGS. 3 and 4 include calculating the probability of a job occurring in a time-interval 0-5 (5 min as sleep timeout). The calculation using the formula described herein is described below with: c=probability of no job occurrence and x=time interval 0-5. So the probability of no job occurrence in time interval 0-5, P(No|0-5) is

$$\begin{matrix}P ( No \vert 0 - 5 ) = \frac{P ( 0 - 5 \vert No ) P ( No )}{P ( 0 - 5 )} \\ = \frac{( 3 / 9 ) ( 9 / 22 )}{( 5 / 22 )} \\ = \frac{( 0.33 ) ( 0.41 )}{( 0.23 )} \\ = 0.59\end{matrix}$$

In a similar manner, the probabilities are calculated for the time-intervals 0-10, 0-15, and 0-20. For the example data from FIGS. 3 and 4, the 0-10 minute time-interval provides the P(No|0-10)=1.59 as the highest probability value among the four time-intervals.

Accordingly, the data analyzer 134 determines the sleep timeout of 10 minutes to be an optimal value for conserving energy, at block 230. The signaling module 136 sends the computed sleep timeout value to the energy-saving module 118 of the device 110. As described herein, the computed sleep timeout value may be sent, in an example, only if the computed value is different from the present sleep timeout value.

The energy-saving module 118 of the device 110 updates the power manager 114 to adjust the sleep timeout to the value received, at block 240. Accordingly, the power management settings of the device 110 are automatically adjusted to optimize energy-saving.

Additional processes also may be included, and it should be understood that the processes depicted in the flow diagram(s) herein represent illustrations and that other processes may be added or existing processes may be removed, modified, or rearranged without departing from the scope and spirit of the present disclosure.

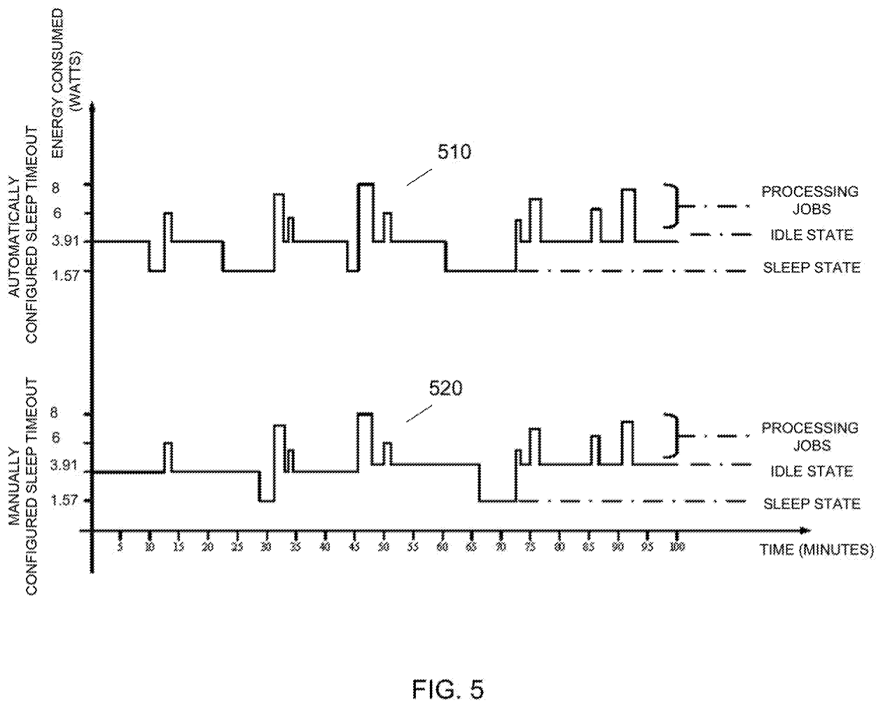

FIG. 5 depicts an example result for the example data from FIGS. 3 and 4. A first plot 510 depicts time spent by the device 110 in the sleep-state and the wake-state (idle/processing jobs) when the sleep timeout is configured according to the value computed by the computing device 120. A second plot 520 depicts time spent by the device 110 in the sleep-state and the wake-state (idle/processing jobs) when the sleep timeout is configured manually based on user assumptions. As can be seen in FIG. 5, with the manual configuration of sleep timeout=15 minutes, the device 110 has idle minutes=62, and sleep minutes=11. Consider that energy consumed in the idle mode=3 Watts, and energy consumed in sleep-state=1.5 Watts. Accordingly, with the manual configuration, the energy consumed=(62.3)+(11*1.5)=202.5 Watts.

In case of the automatic configuration, the sleep timeout is set to 10 minutes, which results in idle minutes=49, and sleep minutes=23. Accordingly, with the automatic configuration, the energy consumed=(49*3)+(23*1.5)=181.5 Watts. Thus, in this case, the automatic configuration saves about 21 Watts of energy.

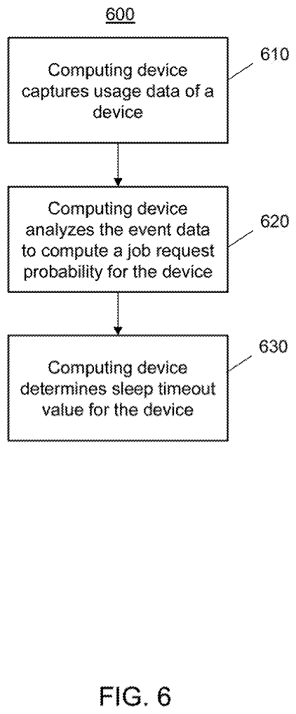

FIG. 6 depicts a depicts a flow diagram of a method 600 for automatically configuring power management settings of a device according to examples described herein. The computing device 120 can perform the method 600 to configure power management settings of the device 110 in an example. In the method 600, the computing device 120 captures usage data of the device 110, at block 610. The usage data includes the time-intervals and a number of times that at least a single job is performed by the device 110 in each of the time-intervals. The computing device 120 captures the usage data using telemetry in an example.

The computing device 120 determines, using the usage data, a probability of a job being requested during a particular time-interval, at block 620. The computing device 120 performs the probability determination using techniques described herein. Further, the computing device 120 determines a sleep timeout value for the device 110. The sleep timeout value indicates a duration for which the device 110 stays in an idle state without receiving a job request, and the device 110 transitions to a sleep-state after that. The computing device 120 sends the sleep timeout value to the device 110. The device 110 configures the power management settings according to the sleep timeout value from the computing device 120.

The technical solutions described herein accordingly provide a practical application and an improvement to computing technology, particularly, configuring electronic devices to conserve energy in an optimal and automatic manner.

It should be emphasized that the above-described examples are merely possible examples of implementations and set forth for a clear understanding of the present disclosure. Many variations and modifications may be made to the above-described examples without departing substantially from the spirit and principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements or processes are intended to be supported by the present disclosure.

What is claimed is:

1. A non-transitory computer-readable storage medium comprising instructions that, when executed by a processing resource of a computing device, cause the processing resource to:
receive usage data of a device, the usage data comprises a plurality of time-intervals and a number of times that at least a single job is performed by the device in each of the time-intervals;
determine, using the usage data, a probability of a job being requested during a particular time-interval; and
configure power management settings of the device for the particular time-interval depending on the probability.

2. The non-transitory computer-readable storage medium of claim 1, wherein the device is a first device, and the usage data is received by a second device, which is separate from the first device.

3. The non-transitory computer-readable storage medium of claim 1, wherein the processing resource is caused to:
filter a stream of event data received from the device to generate the usage data, wherein to filter the stream of event data the processing resource is caused to identify, from the stream of event data, power state events that were caused by a predetermined set of triggers.

4. The non-transitory computer-readable storage medium of claim 3, wherein the predetermined set of triggers comprises job events.

5. The non-transitory computer-readable storage medium of claim 3, wherein the power state events comprise a sleep event and a wake event.

6. The non-transitory computer-readable storage medium of claim 1, wherein to configure the power management settings of the device the processing resource is caused to determine a sleep timeout value for the device, the sleep timeout value indicating a duration for which the device stays in an idle state without receiving a job request, and the device transitions to a sleep-state after that.

7. The non-transitory computer-readable storage medium of claim 6, wherein to configure the power management settings of the device the processing resource is caused to determine that the sleep timeout value is different from a present timeout value; and
responsively, change the present timeout value to the sleep timeout value.

8. The non-transitory computer-readable storage medium of claim 1, wherein the probability is calculated as P(c|x)=P(X|C)P(c)/P(x), where c represents occurrence of a job, x represents the time-interval.

9. A non-transitory computer-readable storage medium comprising instructions that, when executed by a processing resource of a device, cause the processing resource to:
send, to a computing device, usage data of the device, the usage data comprises a plurality of time-intervals and a number of times that at least a single job is performed by the device in each of the time-intervals;
receive, from the computing device, power management settings for the device for a particular time-interval, wherein the computing device determines, using the usage data, a probability of a job being requested during the particular time-interval; and
configure the power management settings of the device.

10. The non-transitory computer-readable storage medium of claim 9, wherein, to determine the probability, the processing resource is caused to filter a stream of event data sent by the device to generate the usage data, wherein to filter the stream of event data the processing resource is caused to identify, from the stream of event data, power state events that were caused by a predetermined set of triggers.

11. The non-transitory computer-readable storage medium of claim 10, wherein the predetermined set of triggers comprises job events.

12. The non-transitory computer-readable storage medium of claim 10, wherein the power state events comprise a sleep event and a wake event.

13. The non-transitory computer-readable storage medium of claim 9, wherein to configure the power management settings of the device, the processing resource is caused to adjust a sleep timeout value for the device, the sleep timeout value indicates a duration for which the device stays in an idle state without receiving a job request, and the device transitions to a sleep-state after that.

14. The non-transitory computer-readable storage medium of claim 9, wherein the probability is calculated as
$$P ( c \vert x ) = \frac{P ( X \vert C ) P ( c )}{P ( x )} ,$$
where c represents occurrence of a job, x represents the time-interval.

15. A method comprising:
capturing usage data of a device, the usage data comprises a plurality of time-intervals and a number of times that at least a single job is performed by the device in each of the time-intervals;
determining, using the usage data, a probability of a job being requested during a particular time-interval; and
determining a sleep timeout value for the device, the sleep timeout value indicating a duration for which the device stays in an idle state without receiving a job request, and the device transitions to a sleep-state after that.
